(19) United States
(12) Patent Application Publication
(10) Pub. No.: US 2022/0327464 A1
(43) Pub. Date: Oct. 13, 2022

(54) Resource Scheduling System

(71) Applicant: S&P Global, New York, NY (US)

(72) Inventors: Hyunyoung Choi, Boston, MA (US); Jeong Wook Choi, Davis, CA (US); Hyojun Ada Lee, Chicago, IL (US)

(21) Appl. No.: 17/301,685

(22) Filed: Apr. 12, 2021

(51) Int. Cl. G06Q 10/06

(52) U.S. Cl. CPC G06Q 10/063118; G06Q 10/063116; G06Q 10/06314

(57) ABSTRACT

A method, apparatus, system, and computer program product for scheduling access to a set of locations. Workers assigned to the set of locations are identified by a set of processor unit. A collaboration network is identified by the set of processor units in which the collaboration network comprises nodes representing the workers and edges having weights representing interactions between the workers in which the interactions are based on communications information sent between the workers in a computer system. A schedule is generated by the set of processor units for the workers to work at the set of locations using the collaboration network.

### BACKGROUND INFORMATION

### 1. Field

The present disclosure relates generally to an improved computer system and, in particular, to a method, apparatus, computer system, and computer program product for scheduling work areas to increase in-person interaction.

### 2. Background

Scheduling can be performed to determine when employees work. A work schedule can be generated for employees to work based on various factors. For example, hours worked per week, hours worked per day, availability of employees, requests for schedule changes, and vacations are some factors that can be taken into account in scheduling employees to use work areas in a location such as an office building.

Scheduling can become more difficult when constraints are present on capacity in an office. For example, work areas available at a location may only be sufficient to support 20 percent or 50 percent of the employees on a daily basis. Government work rules on hours or contiguous days worked by workers can also add to the challenge of generating schedules.

Further, the challenges of creating work schedules increase because these factors and constraints can be dynamic. For example, employees can be added to the work force and unexpected increases in workloads can occur that need to be taken into account in generating schedules. As another example, the available work areas may be set by various rules and regulations that over time change the amount of work areas that are useable in a location. Further, the rules and regulations can sometimes make these changes unexpectedly and without much lead time.

Therefore, it would be desirable to have a method and apparatus that take into account at least some of the issues discussed above, as well as other possible issues. For example, it would be desirable to have a method and apparatus that overcome a technical problem with scheduling workers to work in a location.

### SUMMARY

An embodiment of the present disclosure provides a method for scheduling access to a set of locations. Workers assigned to the set of locations are identified by a set of processor units. A collaboration network is identified by the set of processor units in which the collaboration network comprises nodes representing the workers and edges having weights representing interactions between the workers in which the interactions are based on communications information sent between the workers in a computer system. A schedule is generated by the set of processor units for the workers to work at the set of locations using the collaboration network.

Another embodiment of the present disclosure provides a method for resource scheduling. A schedule is generated by a set of processor units for workers to use work areas in a set of physical locations using a collaboration network comprising nodes representing workers and edges having weights representing interactions between workers in which the interactions are based on communications information sent between the workers. The schedule increases in-person interactions between the workers when working at the set of physical locations using the schedule. A set of actions is performed by the set of processor units using the schedule.

Yet another embodiment of the present disclosure provides a scheduling system comprising a set of processor units and a scheduler in the set of processor units. The scheduler is configured to identify workers assigned to a set of locations. The scheduler is configured to identify a collaboration network comprising nodes representing the workers and edges having weights representing interactions between the workers in which the interactions are based on communications information sent between the workers in a computer system. The scheduler is configured to generate a schedule for the workers to work at the set of locations using the collaboration network.

Still another embodiment of the present disclosure provides a scheduling system comprising a set of processor units and a scheduler in the set of processor units. The scheduler is configured to generate a schedule for workers to use work areas in a set of physical locations using a collaboration network comprising nodes representing workers and edges having weights representing interactions between the workers in which the interactions are based on communications information sent between the workers. The schedule increases in-person interactions between the workers when working at the set of physical locations using the schedule. The scheduler is configured to perform a set of actions using the schedule.

Another embodiment of the present disclosure provides a computer program product for scheduling resources. The computer program product comprises a computer-readable storage media with first program code, second program code, and third program stored on the computer-readable storage media. The first program code is executable by a computer system to cause the computer system to identify workers assigned to a set of locations. The second program code is executable by the computer system to cause the computer system to identify a collaboration network comprising nodes representing the workers and edges having weights representing interactions between the workers in which the interactions are based on communications information sent between the workers in a computer system. The third program code is executable by the computer system to cause the computer system to generate a schedule for the workers to work at the set of locations using the collaboration network. The schedule increases in-person interactions between the workers working at the set of locations using the schedule.

Yet another embodiment of the present disclosure provides a computer program product for scheduling resources. The computer program product comprises a computer-readable storage media with first program code and second program code stored on the computer-readable storage media. The first program code is executable by a computer system to cause the computer system to generate a schedule for workers to use work areas in a set of physical locations using a collaboration network comprising nodes representing the workers and edges having weights representing interactions between the workers in which the interactions are based on communications information sent between the workers. The schedule increases in-person interactions between the workers when working at the set of physical locations using the schedule. The second program code is executable by the computer system to cause the computer system to perform a set of actions with using the schedule.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is a pictorial representation of a network of data processing systems in which illustrative embodiments may be implemented;

FIG. 2 is a block diagram of a resource scheduling environment in accordance with an illustrative embodiment;

FIG. 3 is an illustration of a dataflow in creating a schedule for workers in accordance with an illustrative embodiment;

FIG. 4 is an illustration of weight factors in accordance with an illustrative embodiment;

FIG. 5 is an illustration of a collaboration network in accordance with an illustrative embodiment;

FIG. 6 is an illustration of groupings of workers in accordance with an illustrative embodiment;

FIGS. 7A and 7B are illustrations of a schedule for two days at work in accordance with an illustrative embodiment;

FIGS. 8A and 8B are illustrations of a schedule for three days at work in accordance with an illustrative embodiment;

FIG. 9 is a flowchart of a process for scheduling access to a set of locations in accordance with an illustrative embodiment;

FIG. 10 is a flowchart of a process for scheduling access to a set of locations in accordance with an illustrative embodiment;

FIG. 11 is a flowchart of a process for generating a collaboration network in accordance with an illustrative embodiment;

FIG. 12 is a flowchart of a process for generating a schedule in accordance with an illustrative embodiment;

FIG. 13 is a flowchart of a process for delivering a schedule to workers in accordance with an illustrative embodiment;

FIG. 14 is a flowchart of a process for adjusting an organization of workers in accordance with an illustrative embodiment;

FIG. 15 is a flowchart of a process for scheduling access to a set of physical locations in accordance with an illustrative embodiment; and

FIG. 16 is a block diagram of a data processing system in accordance with an illustrative embodiment.

### DETAILED DESCRIPTION

The illustrative embodiments recognize and take into account one or more different considerations. For example, the illustrative embodiments recognize and take into account that current scheduling techniques focus on space and proximity optimization to generate schedules for people using work areas. The illustrative embodiments recognize and take into account that current techniques focus on seating groups of workers physically close to each other. This physical proximity is used to increase collaboration within the groups of workers. The illustrative embodiments recognize and take into account that these scheduling techniques do not take into account scheduling workers who may come into the office with different frequencies over time.

The illustrative embodiments recognize and take into account that one manner in which productivity can be increased is by increasing in-person collaboration between workers. The illustrative embodiments recognize and take into account that analyzing working relationships between workers can be used to generate schedules for work areas that can be used by workers to increase in-person collaboration between the workers.

Thus, the illustrative embodiments provide a method, apparatus, computer system, and computer program product for resource scheduling. In one illustrative example, workers assigned to a set of locations are identified by a set of processor units. A collaboration network is identified by the set of processor units in which the collaboration network comprises nodes representing the workers and edges having weights representing interactions between the workers in which the interactions are based on communications information sent between the workers in a computer system. A schedule is generated by the set of processor units for the workers to work at the set of locations using the collaboration network. The schedule increases in-person interactions between the workers working at the set of locations using the schedule.

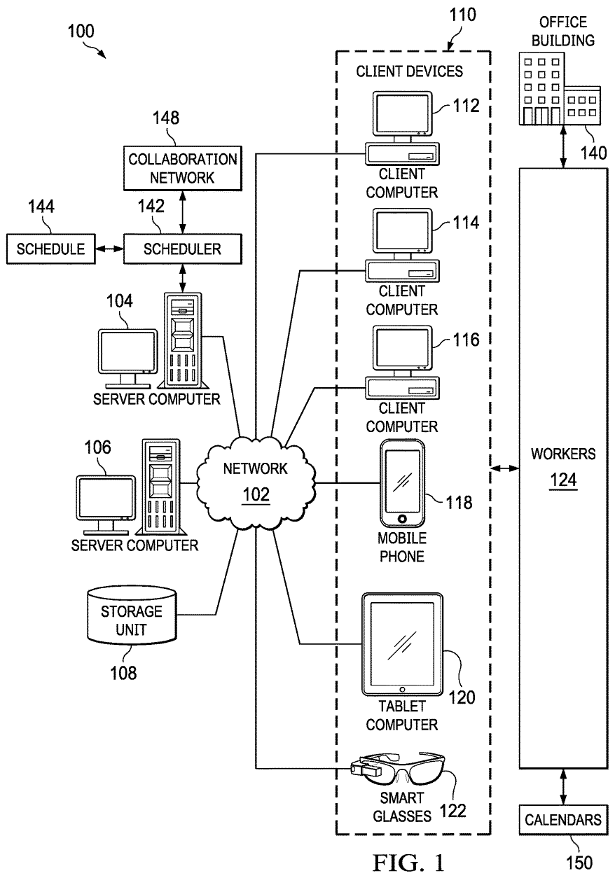

With reference now to the figures and, in particular, with reference to FIG. 1, a pictorial representation of a network of data processing systems is depicted in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server computer 104 and server computer 106 connect to network 102 along with storage unit 108. In addition, client devices 110 connect to network 102. As depicted, client devices 110 include client computer 112, client computer 114, and client computer 116. Client devices 110 can be, for example, computers, workstations, or network computers. In the depicted example, server computer 104 provides information, such as boot files, operating system images, and applications to client devices 110. Further, client devices 110 can also include other types of client devices such as mobile phone 118, tablet computer 120, and smart glasses 122. In this illustrative example, server computer 104, server computer 106, storage unit 108, and client devices 110 are network devices that connect to network 102 in which network 102 is the communications media for these network devices. Some or all of client devices 110 may form an Internet-of-things (IoT) in which these physical devices can connect to network 102 and exchange information with each other over network 102.

Client devices 110 are clients to server computer 104 in this example. Network data processing system 100 may include additional server computers, client computers, and other devices not shown. Client devices 110 connect to network 102 utilizing at least one of wired, optical fiber, or wireless connections.

Program code located in network data processing system 100 can be stored on a computer-recordable storage medium and downloaded to a data processing system or other device for use. For example, program code can be stored on the computer-recordable storage medium on server computer 104 and downloaded to client devices 110 over network 102 for use on client devices 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. Of course, network data processing system 100 also may be implemented using a number of different types of networks. For example, network 102 can be comprised of at least one of the Internet, an intranet, a local area network (LAN), a metropolitan area network (MAN), or a wide area network (WAN). FIG. 1 is intended as an example, and not as an architectural limitation for the different illustrative embodiments.

As used herein, a “number of,” when used with reference to items, means one or more items. For example, a “number of different types of networks” is one or more different types of networks.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

In this illustrative example, workers 124 can work remotely and physically in office building 140. In this illustrative example, different workers in workers 124 can travel to office building 140 on different days during the week to work. As depicted, workers 124 can use client devices 110 to perform work. Client devices 110 can be located in at least one of office building 140 or a remote location. Some of client devices 110 can be transported between office building 140 and the remote location by workers 124.

In this illustrative example, scheduler 142 is software that runs on server computer 104. As depicted, scheduler 142 can generate schedule 144 for workers 124 to work in office building 140. In this example, schedule 144 is information that describes when workers 124 will work in office building 140. For example, schedule 144 can describe times when workers 124 work. These times can be, for example, days, times during a day, or both. Further, schedule 144 can also describe where in office building 140 workers 124 will work. For example, schedule 144 can include work areas or other information.

As depicted, schedule 144 can be generated by scheduler 142 in a manner that increases in-person interaction among workers 124 when workers 124 follow schedule 144. More specifically, scheduler 142 can generate schedule 144 that can result in increases in-person interaction among workers 124 that travel to office building 140 when workers 124 use the schedule generated by scheduler 142. For example, schedule 144 can schedule particular workers on the same days to increase the potential for in-person interactions between those particular workers.

As depicted, scheduler 142 can generate schedule 144 for workers 124 using collaboration network 148. In this example, collaboration network 148 is a data structure in the form of a graph identifies the strength of interactions between workers 124. Scheduler 142 can generate schedule 144 that will increase in-person interactions between workers 124 when physically working in office building 140. In this illustrative example, schedule 144 can be generated such that workers 124 who interact with each other as identified in collaboration network 148 have overlapping times to work in office building 140.

Further, the strength of interactions between workers 124 in collaboration network 148 can be used to schedule overlapping times in schedule 144. For example, workers 124 that have a selected threshold level of interaction can be scheduled to have all times overlap within schedule 144 when possible.

Scheduler 142 can send schedule 144 to client devices 110 used by workers 124 over network 102. Schedule 144 can be sent by scheduler 142 in a number of different ways. For example, scheduler 142 can be sent as a document, a spreadsheet, or some other format to workers 124 via client devices 110. Schedule 144 as received by an individual worker can include portions of schedule 144 that pertains to the worker. Schedule 144 as received by the worker can also include other workers.

In yet another illustrative example, scheduler 142 can send schedule 144 by integrating schedule 144 into calendars 150 for workers 124. In other words, schedule 144 can be input into calendars 150 for workers 124.

As depicted, schedule 144 can be a suggestion of working hours that can result in increased interaction between workers 124. In other words, scheduler 144 may allow workers 124 to choose working hours based on schedule 144.

Further, scheduler 142 can also generate schedule 144 in a manner that reduces office use in addition to increasing in-person interaction between workers 124 working at a physical location such as office building 140.

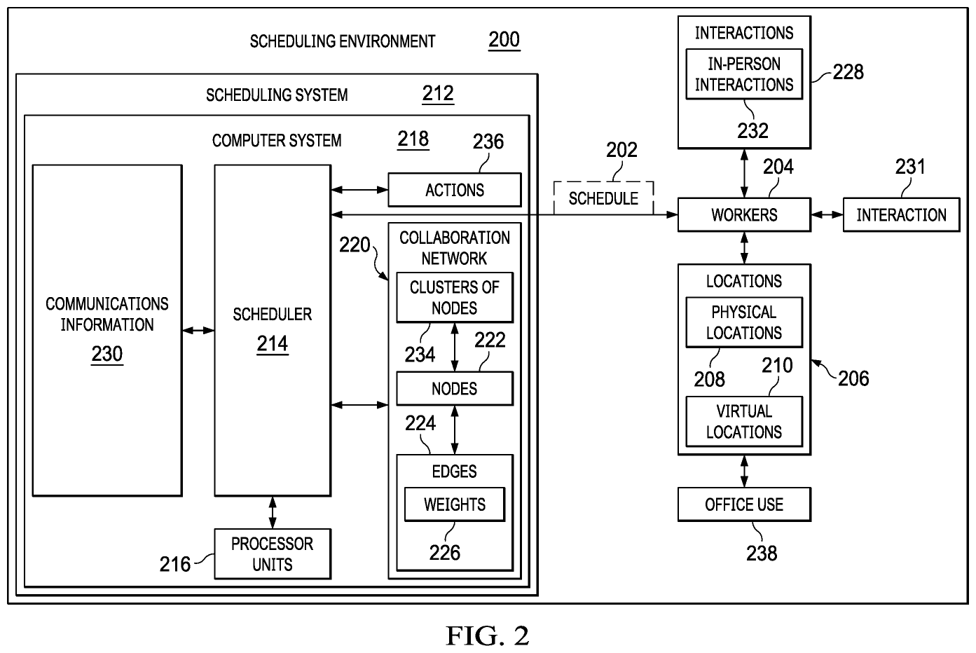

With reference now to FIG. 2, a block diagram of a resource scheduling environment is depicted in accordance with an illustrative embodiment. In this illustrative example, scheduling environment 200 includes components that can be implemented in hardware such as the hardware shown in network data processing system 100 in FIG. 1.

Scheduling environment 200 is an environment in which schedule 202 can be generated for workers 204. Workers 204 can be, for example, selected from at least one of an employee, a self-employed worker, or an independent contractor. Workers 204 can be in the same or multiple organizations.

In this illustrative example, schedule 202 can be optional or required. For example, schedule 202 can be a suggested schedule for workers 204. In this example, workers 204 are associated with a set of locations 206. As a suggested schedule, workers 204 may review schedule 202 and decide whether to work at the set of locations 206 at the times scheduled for workers 204.

In this example, schedule 202 can be for workers 204 to work at a set of locations 206. As used herein, a “set of,” when used with reference to items, means one or more items. For example, a “set of locations” is one or more locations. The set of locations 206 can be selected from at least one of a physical location, a virtual location, an office building, an office complex, a floor, a part of a floor, a city, a metropolitan area, or some other physical location.

In one illustrative example, the set of locations 206 can be a set of physical locations 208. With this example, workers 204 travel to physical locations 208 to perform work. In another illustrative example, the set of locations 206 can be a set of virtual locations 210. As depicted, workers 204 can work in the set of virtual locations 210 using virtual reality or other immersive technologies. When virtual reality or other immersive technologies are used, digital simulations of a real or imagined physical location such the floor of an office, an office building, a campus, or other location can be provided to workers 204.

The set of virtual locations 210 can also include meetings or conference rooms through which workers 204 can meet using video telephony software such as Zoom, Microsoft Teams, or Cisco WebEx. Zoom is available from Zoom Video Communications, Inc.; Microsoft Teams is available from Microsoft Corporation; and Cisco WebEx is available from Cisco Systems, Inc. In other illustrative examples, a mix of physical locations 208 and virtual locations 210 can be present in the set of locations 206.

In this illustrative example, schedule 202 for workers 204 can be generated by scheduling system 212. In this illustrative example, scheduling system 212 comprises scheduler 214 and a set of processor units 216. Scheduler 214 is located in the set of processor units 216.

Scheduler 214 can be implemented in software, hardware, firmware, or a combination thereof. When software is used, the operations performed by scheduler 214 can be implemented in program code configured to run on hardware, such as a processor unit. When firmware is used, the operations performed by scheduler 214 can be implemented in program code and data and stored in persistent memory to run on the processor unit. When hardware is employed, the hardware may include circuits that operate to perform the operations in scheduler 214. For example, hardware can implemented within the set of processor units 216 or processes performed by scheduler 214.

In the illustrative examples, the hardware may take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein, a processor unit is a hardware device and is comprised of hardware circuits such as those on an integrated circuit that respond and process instructions and program code that operate a computer. When a number of processor units execute instructions for a process, the number of processor units is one or more processor units that can be on the same computer or on different computers. In other words, the process can be distributed between processor units on the same or different computers in a computer system. Further, the number of processor units can be of the same type or different type of processor units. For example, a number of processor units can be selected from at least one of a single core processor, a dual-core processor, a multi-processor core, a general-purpose central processing unit (CPU), a graphics processing unit (GPU), a digital signal processor (DSP), or some other type of processor unit.

As depicted, processor units 216 are located in computer system 218 which is a physical hardware system and includes one or more data processing systems. When more than one data processing system is present in computer system 218, those data processing systems are in communication with each other using a communications medium. The communications medium may be a network. The data processing systems may be selected from at least one of a computer, a server computer, a tablet, or some other suitable data processing system.

In one illustrative example, scheduler 214 can schedule access to the set of locations 206. Scheduler 214 can identify workers 204 assigned to the set of locations 206. In other illustrative examples, scheduler 214 can have the option to assign workers 204 to particular locations in the set of locations 206.

Scheduler 214 can identify collaboration network 220 for workers 204. Collaboration network 220 is a data structure containing information that can be used to generate schedule 202 for workers 204. Collaboration network 220 can be used by scheduler 214 to generate schedule 202 for workers 204.

As depicted, collaboration network 220 comprises nodes 222 and edges 224. Each edge in edges 224 connects two nodes in nodes 222 to each other.

In this illustrative example, nodes 222 represent workers 204. A node in nodes 222 represents a single worker or a plurality of workers in workers 204.

Edges 224 can have weights 226 representing interactions 228 between workers 204 in which interactions 228 are based on communications information 230 sent between workers 204 in computer system 218. In this illustrative example, communications information 230 can be at least one of an email message, an instant messaging message, a chat message, a memorandum, a text message, or other information that is used by workers 204 to communicate with each other.

As depicted, scheduler 214 can identify communications information 230 sent between workers 204 within computer system 218 in which workers 204 are associated with the set of locations 206. Scheduler 214 can generate collaboration network 220 using communications information 230. Communications information 230 can be used to determine how much interaction 231 is present between workers 204. Scheduler 214 can determine weights 226 for edges 224 using communications information 230.

In one illustrative example, scheduler 214 can identify one or more clusters of nodes 234 in nodes 222 in collaboration network 220 based on communications between workers 204. For example, a cluster of nodes in clusters of nodes 234 can be a plurality of nodes 222 that are connected to each other directly or indirectly by edges 224. For example, Node A is connected to Node B by Edge 1, and Node A is connected to Node C by Edge 2. Node A, Node B, and Node C are a cluster of nodes in this example.

In this illustrative example, scheduler 214 can generate schedule 202 for workers 204 to work at the set of locations 206 using collaboration network 220. In the illustrative example, schedule 202 increases in-person interactions 232 between workers 204 working at the set of locations 206 using schedule 202. In-person interactions 232 can be physical in-person interactions at a physical location or virtual in-person interactions in a virtual location.

For example, scheduling can be performed to create overlaps in time between workers 204 in clusters of nodes 234. In other words, workers 204 in a cluster of nodes can be scheduled to have overlapping times, such as the same days of the week to work at a particular location in the set of locations 206. This overlap can facilitate an increase of in-person interactions 232 between those workers in clusters of nodes 234.

In the illustrative example, scheduler 214 schedules overlapping times for as many workers as possible within a cluster of nodes. In some cases, a limit may be present as to how many of workers 204 can be scheduled to have fully overlapping times based on availability of work areas in the set of locations 206.

In another illustrative example, scheduling can be for particular nodes representing workers 204 who have an edge with a weight that exceeds a threshold. In other words, workers 204 in two nodes in nodes 222 can be scheduled to have overlapping times for working in the same location or same locations in the set of locations 206.

In another illustrative example, scheduling performed by scheduler 214 can increase in-person interactions 232 between workers 204 outside clusters of nodes 234 in a location. This increase in in-person interactions 232 can occur through scheduler 214 identifying clusters of nodes 234 that share more of edges 224.

Using clusters of nodes 234 can increase in-person interactions 232 within cluster of nodes 234 because workers 204 in the same clusters in clusters of nodes 234 are scheduled on the same day in schedule 202. Additionally, different clusters in clusters of nodes 234 can be scheduled together in schedule 202 such that two clusters in clusters of nodes 234 that share more edges in edges 224 are scheduled on the same day in schedule 202. In other words, two nodes 222 can be grouped into two clusters in which nodes 222 in one cluster can have edges 224 that connect to nodes 222 in another cluster.

Scheduling performed by scheduler 214 can also increase interactions between workers 204 by scheduling working hours within schedule 202. With the increase in virtual working, scheduler 214 can be used to schedule hours or days for workers 204 online to increase in-person interactions 232 and promote collaboration between workers 204.

In this illustrative example, scheduler 214 can perform a set of actions 236 using schedule 202. The set of actions 236 can take a number of different forms. For example, the set of actions 236 can be selected from at least one of: sending a schedule to workers, populating a calendar with the schedule, sending the schedule to a calendar service for the workers, making a reservation for a work area in a physical location in a set of physical locations, or other suitable actions.

As a result, schedule 202 can be generated to increase in-person interactions 232. Further, scheduler 202 can also increase efficiency of office use 238 for the set of locations 206. For example, office use 238 can be reduced for workers 204. By reducing office use 238, additional workers can be scheduled to work in the set of locations 206.

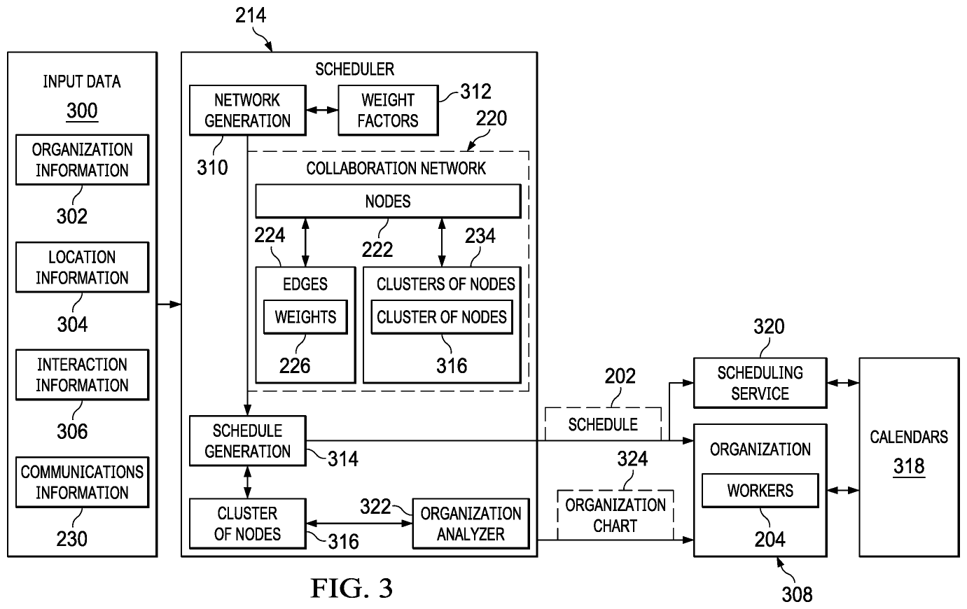

Turning next to FIG. 3, an illustration of a dataflow in creating a schedule for workers is depicted in accordance with an illustrative embodiment. In the illustrative examples, the same reference numeral may be used in more than one figure. This reuse of a reference numeral in different figures represents the same element in the different figures.

In this illustrative example, scheduler 214 includes a number of different processes used to generate schedule 202 for workers 204. In this illustrative example, scheduler 214 receives input data 300 for use in generating schedule 202. As depicted, input data 300 comprises organization information 302, location information 304, interaction information 306, and communications information 230.

Organization information 302 is information about organization 308 in which workers 204 are located. In this illustrative example, organization 308 can take a number of different forms. For example, organization 308 can be a company, a corporation, an institution, a government entity, a charity, a social group, a team, a city, or some other suitable entity. Organization information 302 can include information about the organization or structuring of workers 204. Organization information 302 can include an organizational chart or an organigram for workers 204. An organigram is a data structure defining the organization and relationship of workers 204.

In this illustrative example, location information 304 can include information about the set of locations 206. Location information 304 can include information such as an identification of work areas, occupancy limits, or other information about locations 206 for workers 204 to work. For example, occupancy limits can be 20 percent of a work area, percent of workers 204, or some other constraint on how many work areas can be used. In this illustrative example, a work area can be an office, a desk, a conference room, or some other area in which workers 204 can perform work.

Interaction information 306 is information used to determine the amount or level of interactions 228 in FIG. 2 between workers 204. The amount or level of interactions 228 can be historical, present, or predicted future interactions. Interaction information 306 can be used to determine weights 226 for edges 224 in collaboration network 220.

A current project can be used in determining expected current interactions between workers 204. For example, a project can be assigned to a group of workers 204. The project can include information as to responsibilities, deliverables, and other information as well as assignments to particular workers in the group of workers 204. This information can be used to determine the amount of interaction that occurs between workers 204 and the group of workers 204 assigned to the project.

Future projects can be used to predict future interactions between workers 204. A future project can be one that is yet to be assigned to a group of workers 204. The future project and the identification of workers 204 that will be assigned to the future project can be used to predict the amount of interaction that will occur once the future project has been assigned.

In this illustrative example, network generation 310 in scheduler 214 can generate collaboration network 220 using input data 300. For example, network generation 310 can use organization information 302 to identify nodes 222.

Further, scheduler 214 can use communications information 230 to determine weights 226. Adjustments to weights 226 can be made using weight factors 312. As depicted, weight factors 312 can be determined using information such as interaction information 306, organization information 302, and other information that may indicate how much interaction occurs or is expected to occur between workers 204. In other words, scheduler 214 can determine weights 226 for edges 224 using communications information 230 and a set of weight factors 312.

In this illustrative example, collaboration network 220 can be used by schedule generation 314 to generate schedule 202 for workers 204. In generating schedule 202, schedule generation 314 can identify cluster of nodes 316 in nodes 222 based on connections between nodes 222 by edges 224. In this illustrative example, the size of cluster of nodes 316 can have a limit. For example, cluster of nodes 316 may initially be determined to have 16 nodes. This cluster of nodes can be broken up into two clusters of nodes depending on various factors. For example, the size of cluster of nodes 316 can be limited by at least one of an office capacity or a number of days of work.

In this illustrative example, cluster of nodes 316 contains nodes 222 for workers 204 for which in-person interaction is likely if workers in workers 204 have schedules in which they are in the office on some or all of the same days.

In this illustrative example, schedule generation 314 can send schedule 202 to organization 308 populate calendars 318 for workers 204 with schedule 202 for workers 204. In this example, calendar 318 populated with schedule 202 can be for a worker and have entries for the worker based on schedule 202. In another illustrative example, calendar 318 for the worker can also have entries for other workers in workers 204. These other workers can be workers 204 for which the worker is likely to have or may desire in-person interactions at the set of locations 206 in FIG. 2.

In another illustrative example, schedule 202 can be sent directly to workers 204 and organization 308. Workers 204 may update their calendars 318 using schedule 202.

In yet another illustrative example, schedule 202 can be sent to scheduling service 320. Scheduling service 320 can be a service used by organization 308 to manage schedules for workers 204. In this illustrative example, scheduling service 320 can populate calendars 318 for workers 204.

As depicted, scheduler 214 can also provide insight into the structure of organization 308. For example, organization analyzer 322 can compare workers 204 in clusters of nodes 234 in collaboration network 220 to organization information 302. For example, workers 204 in clusters of nodes 234 can be compared to teams or groups of workers 204 as defined or set up in organization information 302.

For example, cluster of nodes 316 can be comprised of a single team or a plurality of teams of workers 204. A team is comprised of one or more of workers 204. If workers 204 in cluster of nodes 316 are all in more than one team or group of workers 204 as defined by the organizational chart for organization 308, the organization of workers 204 is defined in an organizational chart that can be changed to reflect the grouping of workers 204 in cluster of nodes 316.

As a result, the organization of workers 204 can be changed based on the alignment between the organization of workers 204 into a set of groupings of workers 204 and workers 204 in clusters of nodes 234. Organization chart 324 can be generated by organization analyzer 322 to reflect the changes suggested for organization 308.

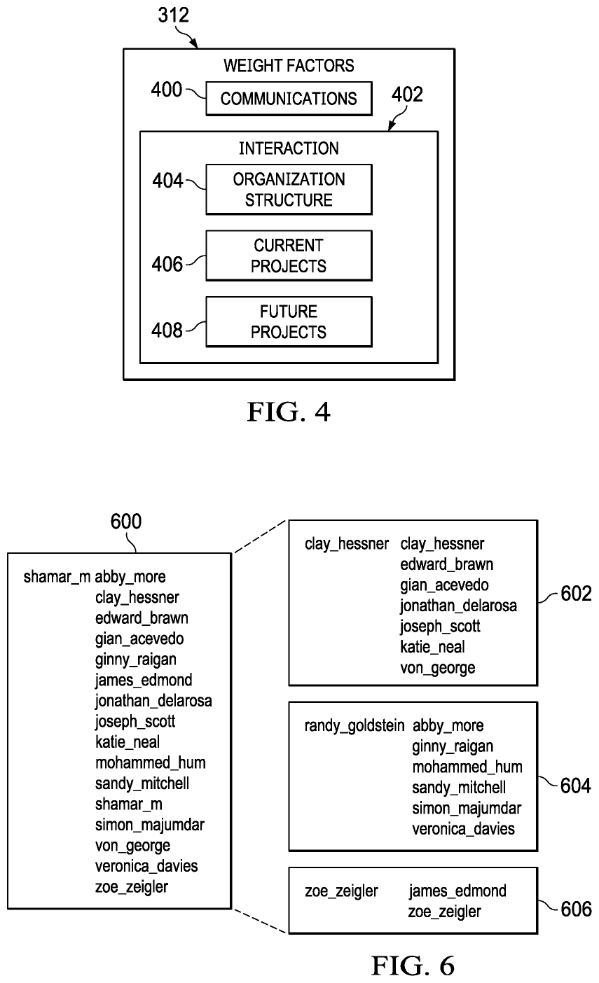

Turning next to FIG. 4, an illustration of weight factors is depicted in accordance with an illustrative embodiment. Weight factors 312 depicted in this figure are examples of weight factors that can be used to determine weights 226 for edges 224 in collaboration network 220 in FIGS. 2-3. In this illustrative example, weight factors 312 include communications 400 and interaction 402.

Communications 400 can be determined from communications information 230 in FIGS. 2-3. The value can be given to communications between workers 204 represented by nodes 222 in FIG. 2. Communications 400 can be used to identify values for weights 226 in FIGS. 2-3. For example, a weight for an edge can be a function y=x, where x is a level of communications derived from communications information 230. This function can be used to generate the weight for each edge in edges 224.

These weights can be adjusted by interaction 402. Interaction 402 can include, for example, organization structure 404, current projects 406, future projects 408, and other information that uses factors to indicate interaction between workers 204. In this illustrative example, reporting chains in organization structure 404 can be x1 and current projects 406 can be x2. The weight function y=x can be adjusted as follows: y=x+x1+x2.

In another illustrative example, an addition of a weight factor such as x3 for future projects can be used to form the weight function y=x+x1+x2+x3. Future projects 408 to be assigned to workers 204 can be used to predict interactions that will occur between workers 204 when those future projects are assigned and can be taken into account in weights 226.

The illustration of weight factors 312 in FIG. 4 is provided for illustrating one manner in which weight factors 312 can be implemented. This illustrative is not meant to limit the manner in which weight factors 312 can be implemented in other examples. For example, future projects 408 may be from weight factors 312 in another example. In yet another example, relationships can be identified between workers 204 is another factor in interaction 402 that can be taken into account as a weight factor in determining weights 226 for edges 224.

In one illustrative example, one or more technical solutions are present that overcome a technical problem with scheduling workers to work in a location. As a result, one or more technical solutions can provide a technical effect of providing data structures containing information, such as schedule 202, that can be used workers 204 to perform actions or take steps in working in a set of locations 206 that increase in-person interactions 232.

The set of processor units 216 in computer system 218 in FIG. 2 can be configured to perform at least one of the steps, operations, or actions described in the different illustrative examples using software, hardware, firmware, or a combination thereof. As a result, computer system 218 with the set of processor units 216 operates as a special purpose computer system in which scheduler 214 in the set of processor units 216 in computer system 218 enables generating schedule 202 for workers 204 in a manner that can be used to increase in-person interactions 232. In the illustrative examples, scheduler 214 uses communications information 230 to create schedule 202. As depicted, scheduler 214 creates a data structure, such as collaboration network 220, that is used to generate schedule 202. In illustrative example, scheduler 214 schedules workers 204 within a cluster of nodes to have the same or some of the same days to work in a location in locations 206. Scheduler 214 transforms computer system 218 into a special purpose computer system as compared to currently available general computer systems that do not have scheduler 214.

In the illustrative example, the use of scheduler 214 in the set of processor units 216 in computer system 218 integrates processes into a practical application for scheduling resources such as work areas in physical locations.

Thus, scheduler 214 can generate schedule 202 in a manner that increases in-person interaction between workers 204 following schedule 202 to work at the set of locations 206. Additionally, scheduler 214 can also generate schedule 202 such that office use is reduced in addition to increasing in-person interactions between workers 204 when working at the set of locations 206 using schedule 202.

Scheduler 214 can provide schedule 202 that enables workers 204 to make decisions as to whether or when to work at the set of locations 206. Schedule 202 can set times for workers 204 to work in a set of locations 206 that enable increased or desired levels of in-person interactions between workers 204. Workers 204 can plan work or actions based on schedule 202. Schedule 202 can also include information about coworkers for workers 204 that have levels of communication that indicate in-person interactions 232 are likely to occur if those workers have schedules with at least some overlapping times.

The illustration of scheduling environment 200 and the different components in scheduling environment 200 in FIGS. 2-4 are not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, although scheduler 214 is described as generating schedule 202 for a single physical location, scheduler 214 can generate schedules for workers 204 who may work in other physical locations in addition to or in place of the physical location. As another example, although scheduler 214 is shown in the same computer system as communications information 230 sent between workers 204, scheduler 214 can be in a separate computer system from the computer system in which workers 204 send communications to each other.

In yet another illustrative example, another component of scheduler 214 can generate collaboration network 220. With this example, scheduler 214 identifies collaboration network 220 and uses collaboration network 220 to generate schedule 202. In other words, scheduler 214 can identify collaboration network 220 by performing a search, sending a request, or other action that can be used to locate and obtain collaboration network 220 for use in generating schedule 202.

In yet another illustrative example, one or more of collaboration network 220 can be present in addition to collaboration network 220. These other collaboration networks can be used to generate schedules for other workers in other organizations to work at the set of locations 206 or other locations. In still another illustrative example, scheduler 214 can generate reservations for work areas in the set of locations 206 for workers 204 using schedule 202.

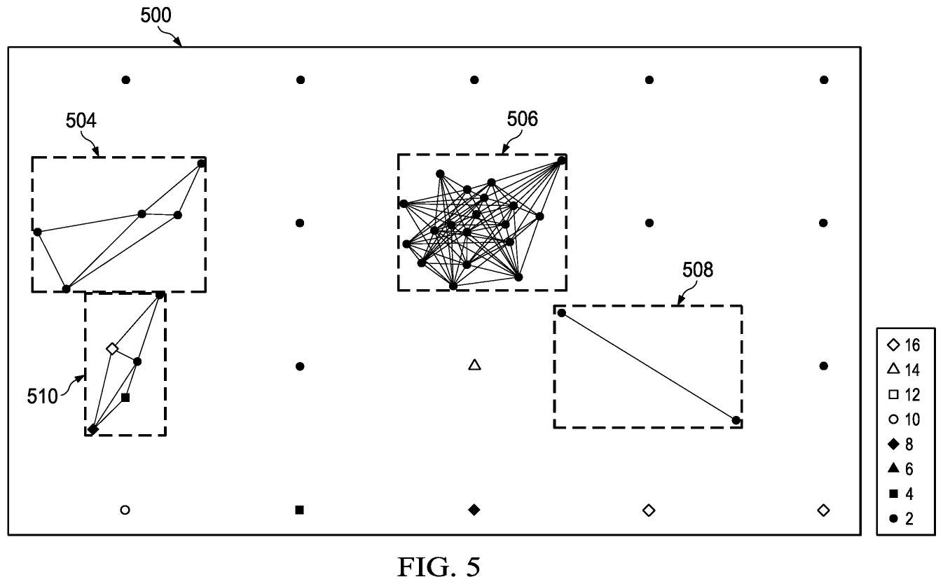

With reference next to FIG. 5, an illustration of a collaboration network is depicted in accordance with an illustrative embodiment.

Collaboration network 500 is a visualization of a data structure and is an example of one implementation for collaboration network 220 in FIG. 2-3.

As depicted, collaboration network 500 includes nodes. Each node can represent an individual worker or a group or team of two or more workers. In this illustrative example, the number of workers represented in a node can be indicated using color.

In this illustrative example, a portion of the nodes are connected by edges. These edges represent communications between the nodes. Each edge has a weight not displayed in this visualization of collaboration network 500. In other examples, the weights can be visualized through graphical indicators such as line thickness, line type, color, animation, or other graphical indicators.

As depicted, clusters are identified within collaboration network 500. The clusters include cluster 504, cluster 506, cluster 508, and cluster 510. Scheduling of workers represented by the nodes can be made based on identification of the clusters within collaboration network 500.

Nodes that are part of a cluster can be determined in a number of different ways. For example, two nodes can be considered part of a cluster based on the presence of an edge, a weight of an edge, or some other suitable factor.

Further, after generating a collaboration network, one or more clusters of nodes can be present. These clusters of notes can be processed to determine whether the clusters of nodes can be subdivided into additional clusters of nodes. For example, edges can be iteratively removed, and the remaining nodes and edges can be clusters of nodes that will be used to generate a schedule.

For example, nodes A, B, and C are connected to each other by edges 1, 2, 3; nodes D, E, and F are connected to each other by edges 4, 5, 6; and nodes C and D are connected to each other by edge 7. In this example, edge 7 is a bridge between nodes A, B, and C and nodes D, E, and F. Edge 7 can be removed leaving a first cluster of nodes A, B, and C and a second cluster of nodes D, E, and F.

Turning to FIG. 6, an illustration of groupings of workers is depicted in accordance with an illustrative embodiment. In this illustrative example, group 600 is a grouping of workers defined by organization information. This grouping can be workers that are part of a team as defined in an organizational chart or other organization information.

As depicted, group 602, group 604, and group 606 are groupings based on clusters identified in a collaboration network. Each of these groups can be used to generate schedules such that the workers in each of the groups are more likely to have in-person interactions when working a set of locations using a schedule. For example, the workers in a group can be scheduled to have more overlapping days or times to increase the likelihood of in-person interaction between the workers within one of these groups corresponding to the clusters.

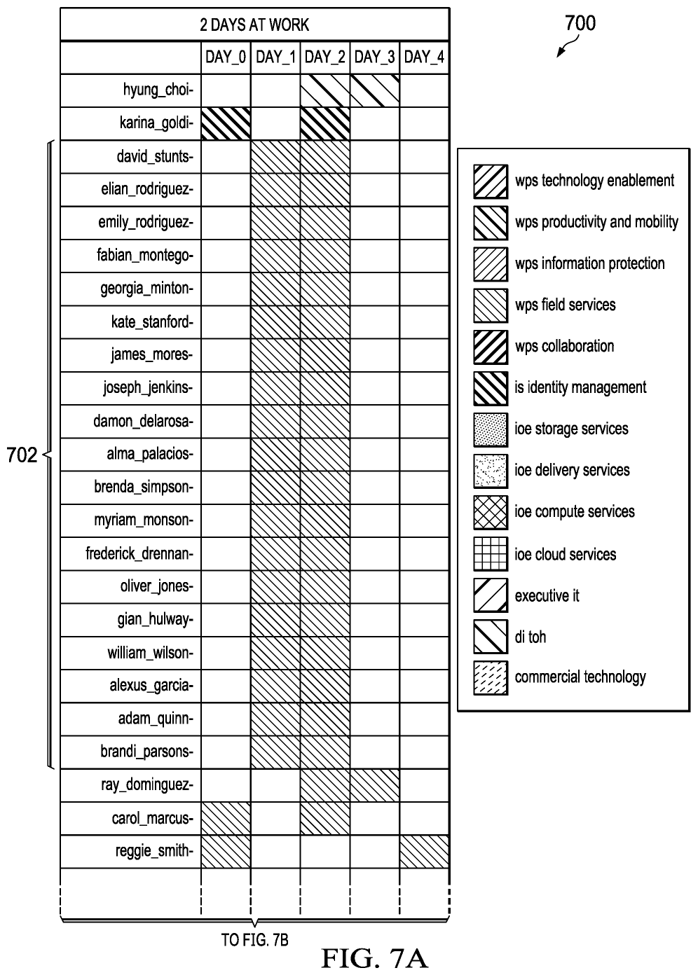

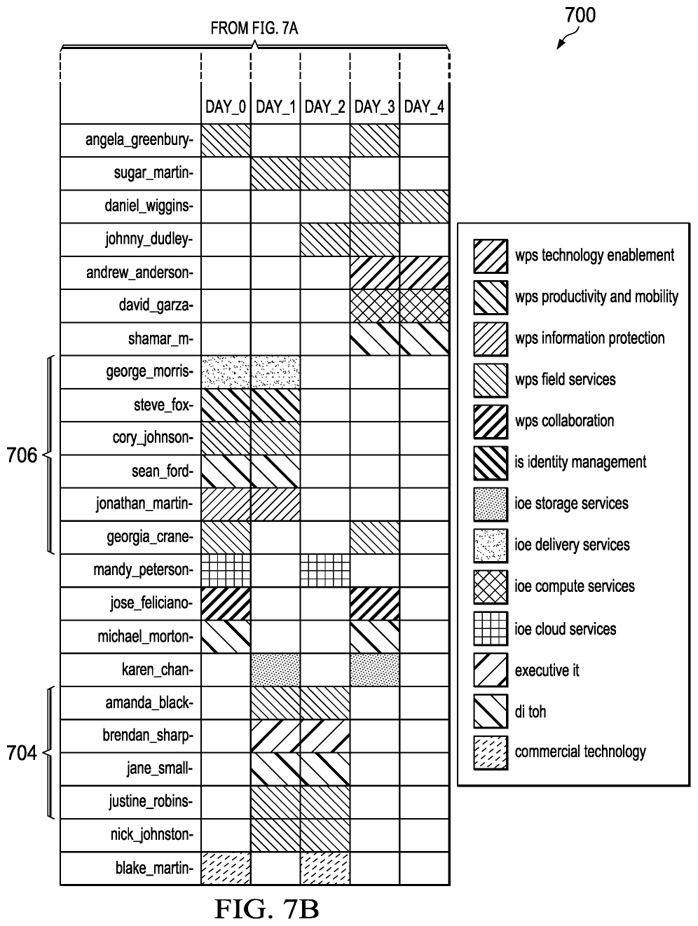

Turning next to FIGS. 7A and 7B, illustrations of a schedule for two days at work is depicted in accordance with an illustrative embodiment. In this illustrative example, schedule 700 schedules workers to work a two-day schedule. In other words, each worker is scheduled for two days in a five-day workweek in this illustrative example.

As depicted, the schedules provide overlaps or same-day in-office working for workers who have been identified as likely to have in-person interactions if provided the opportunity when scheduling days in the office.

For example, the workers in section 702 have been identified as workers in the same team and have been identified as being in a cluster. The cluster indicates that the workers in section 702 have communications with each other. In this example, the workers in section 702 are all scheduled to work on day one and day two in schedule 700. By scheduling these workers in section 702 to be in a location on the same days, opportunities for in-person interactions are increased.

As another example, the workers in section 704 have been identified as being in a cluster and are scheduled to work day one and day two in the location. All of these workers are not on the same team, but are scheduled to have the same days as a result of being identified as being in the same cluster.

In yet another example, the workers in section 706 are identified as being part of the same cluster. In this example, all but one of the workers in section 706 are scheduled to have two overlapping days. One worker does not have two overlapping days with the other workers in section 706. This type of scheduling can result based on the availability of work areas within the location.

The selection of workers in a cluster of overlapping days while some workers in the cluster may not have overlapping days can be based on factors such as the amount of interaction between the workers in a particular cluster, availability of work area in a location, or other suitable factors.

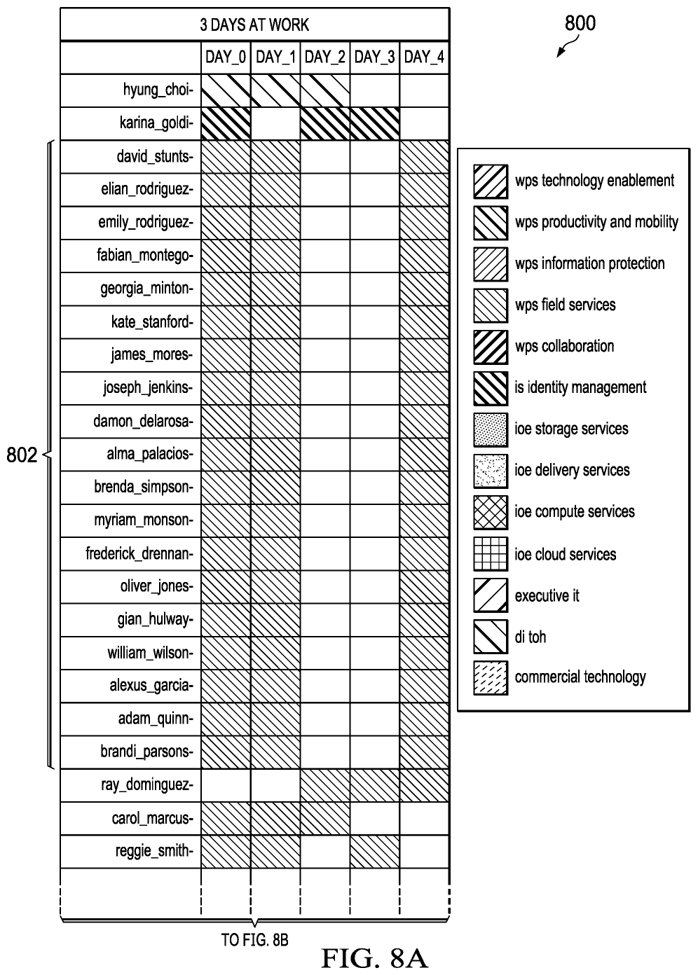

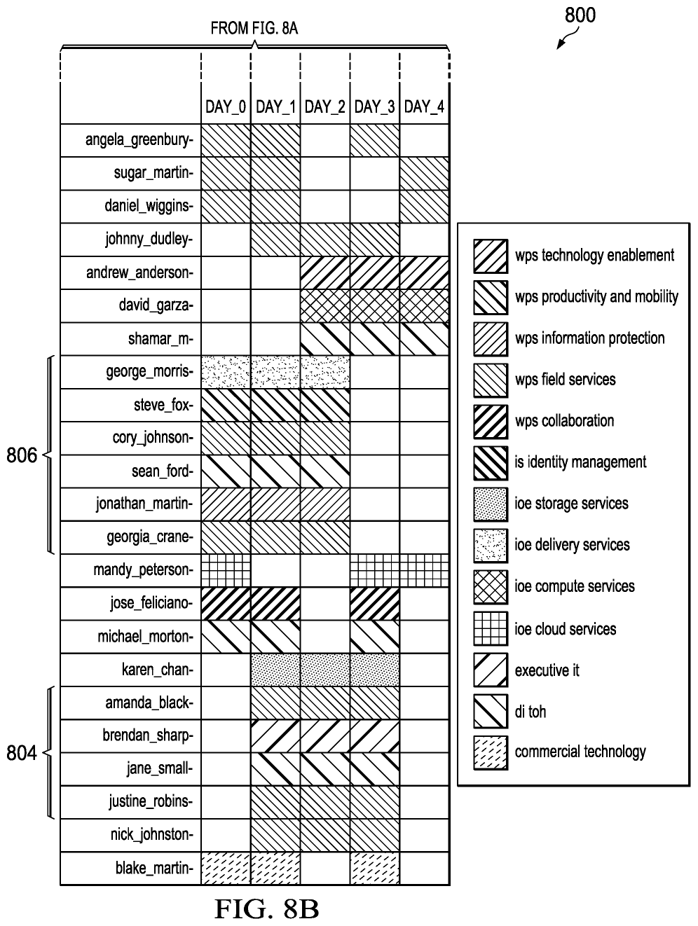

With reference to FIGS. 8A and 8B, illustrations of a schedule for three days at work is depicted in accordance with an illustrative embodiment. In this illustrative example, schedule 800 schedules workers to work a three-day schedule. In other words, each worker is scheduled for two days in a five-day workweek in this illustrative example.

The workers in section 802 correspond to the same workers in section 702 in FIG. 7A. As can be seen in this depicted example, the workers in section 802 are scheduled to work the same three days.

As depicted, workers in section 804 correspond to the workers in section 704 in FIG. 7B. These workers are also scheduled to work the same three days. As another example, the workers in section 806 correspond to the workers in section 706 in FIG. 7B. With the increased number of workdays, more flexibility is present in providing overlapping days between workers. As can be seen, the workers in section 806 now all work the same three days as compared to these workers from the two-day schedule illustrated in schedule 700 in FIGS. 7A and 7B.

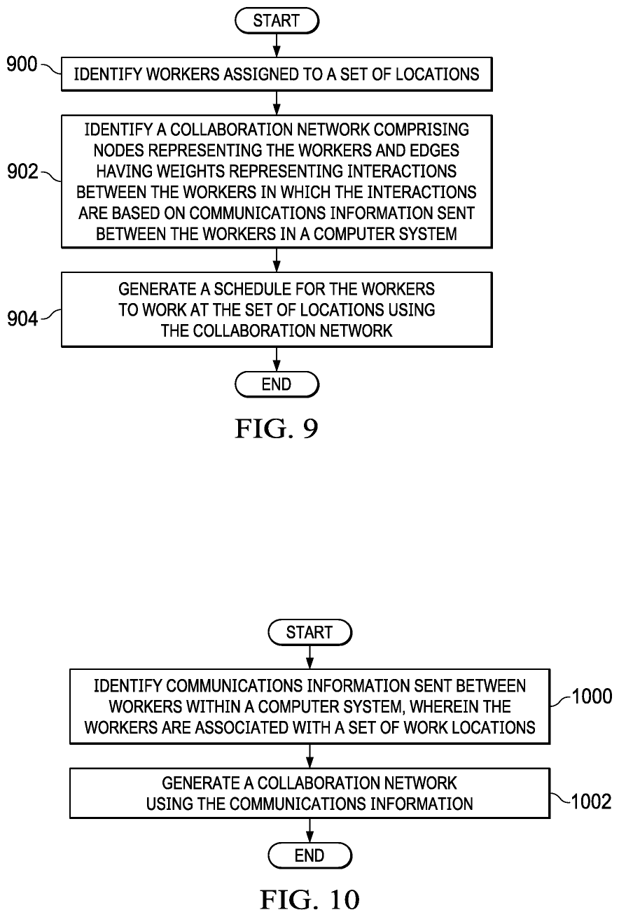

Turning next to FIG. 9, a flowchart of a process for scheduling access to a set of locations is depicted in accordance with an illustrative embodiment. The process in FIG. 9 can be implemented in hardware, software, or both. When implemented in software, the process can take the form of program code that is run by one or more processor units located in one or more hardware devices in one or more computer systems. For example, the process can be implemented in at least one of scheduler 142 in server computer 104 in FIG. 1 or scheduler 214 in processor units 216 in computer system 218 in FIG. 2.

The process begins by identifying workers assigned to a set of locations (step 900). In step 900, the set of locations can be selected from at least one of a physical location or a virtual location. In other words, when more than one location is present in the set of locations, both physical and virtual locations can be present. The process identifies a collaboration network comprising nodes representing the workers and edges having weights representing interactions between the workers in which the interactions are based on communications information sent between the workers in a computer system (step 902).

The process generates a schedule for the workers to work at the set of locations using the collaboration network (step 904). The process terminates thereafter. In step 904, the schedule increases in-person interactions between the workers working at the set of locations using the schedule. The schedule can also reduce or optimize the usage of work areas in the set of locations. In other words, the schedule can reduce how much work area is needed as compared to another schedule generated by a different process with the same number of workers.

Turning now to FIG. 10, a flowchart of a process for scheduling access to a set of locations is depicted in accordance with an illustrative embodiment. The process in this flowchart includes additional steps that can performed with the steps in the flowchart in FIG. 9.

The process identifies communications information sent between workers within a computer system, wherein the workers are associated with a set of work locations (step 1000). The process generates a collaboration network using the communications information (step 1002). The process terminates thereafter.

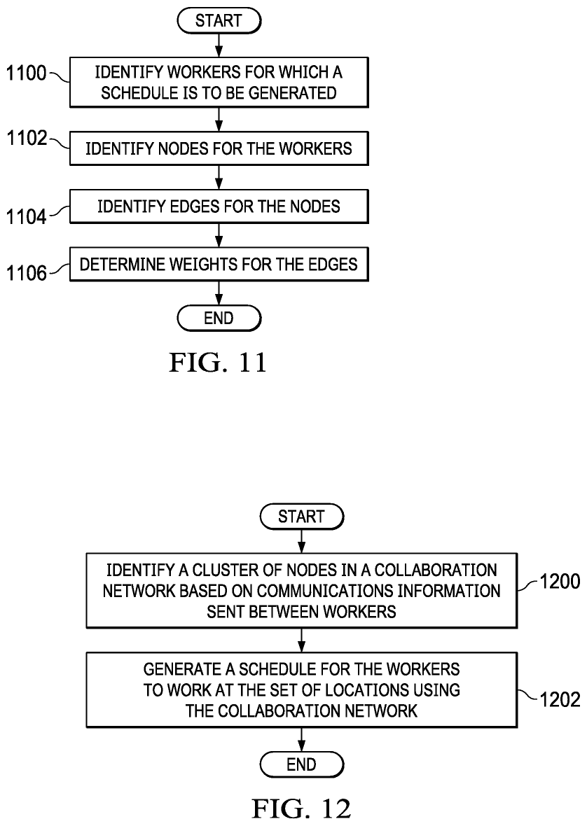

With reference now to FIG. 11, a flowchart of a process for generating a collaboration network is depicted in accordance with an illustrative embodiment. This flowchart illustrates one manner in which step 1002 in FIG. 10 can be implemented.

The process identifies workers for which a schedule is to be generated (step 1100). In step 1100, the workers can be identified from various sources such as a list of workers, an organizational chart, user input, or from some other source.

The process then identifies nodes for the workers (step 1102). In step 1102, a node can represent a single worker or multiple workers. For example, the neighboring can represent a team or a department in an organization.

The process identifies edges for the nodes (step 1104). In this step, an edge can be identified between two nodes based on communications between the workers in the two nodes.

The process determines weights for the edges (step 1106). The process terminates thereafter. In this step, the weight for an edge between two nodes can be determined based on communications between the workers in the two nodes. For example, an amount of communications and a frequency of communications can be used to determine the weight. This weighting can be performed using a weighted function based on communications information identified for the workers in the two nodes.

Further, the weight in step 1106 can also be determined using weight factors for the workers in addition to the communications information between the workers in the two nodes. For example, the weight factors can be at least one of a reporting chain for the workers, a current project, a future project, or some other factor.

In FIG. 12, a flowchart of a process for generating a schedule is depicted in accordance with an illustrative embodiment. The process illustrated in FIG. 12 is an example of the steps that can be used implement step 904 in FIG. 9.

The process identifies a cluster of nodes in a collaboration network based on communications information sent between workers (step 1200). The process generates a schedule for the workers to work at a set of locations using the collaboration network (step 1202). The process terminates thereafter. The generated in step 1202 overlaps times that the workers in the cluster of nodes access the set of locations. For example, the process can schedule the workers in a cluster to work on the same days a week in a location. As another example, the process can schedule the workers in a cluster such that they work some of the same days of the week in a location. Having a partial overlap in the days of the week when workers in a cluster are scheduled to work in a location can occur if a constraint is present with the location. Further, this partial overlap may occur when taking into account scheduling workers in other clusters. In other words, the scheduler can be performed such that in-person interactions are increased as a whole for all workers who may work in a location rather than a particular cluster of workers.

In some cases, limitations may be present on how many workers can be scheduled on a particular day. In this situation, the determination of which workers in a cluster can be selected based on various factors. For example, the frequency of communications between workers in a cluster can be used to select which workers will be scheduled on overlapping days. The size of the cluster can be determined by a threshold for the size of a cluster. The size can be the number of workers in a cluster. As are result, if the threshold for a cluster is 10, all clusters will have a number of workers less than or equal to 10, and workers in the same cluster can be scheduled go to office on the same days.

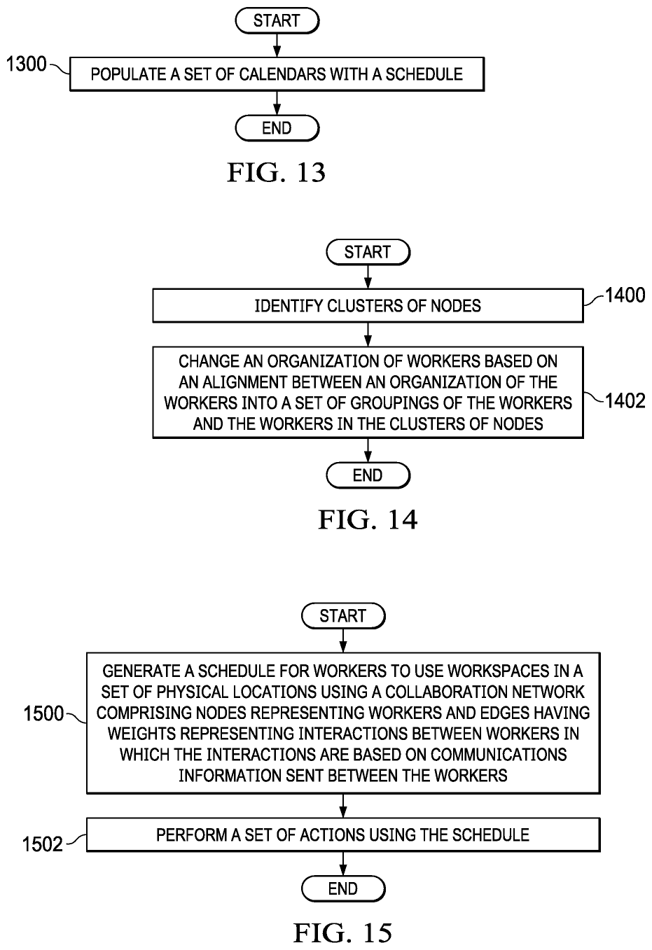

With reference now to FIG. 13, a flowchart of a process for delivering a schedule to workers is depicted in accordance with an illustrative embodiment. The steps in this flowchart are examples of an additional step that can be formed in the process in FIG. 9.

The process populates a set of calendars with a schedule (step 1300). The process terminates thereafter. In this step, a calendar in the set of calendars is populated for a worker such that the calendar includes the days scheduled for work. In the illustrative example, the calendar can also include entries for days scheduled for other workers. These other workers can be workers in a cluster with the worker, the worker's team, or other workers whose schedule may be of interest for relevant to the worker.

In FIG. 14, a flowchart of a process for adjusting an organization of workers is depicted in accordance with an illustrative embodiment. The process in this flowchart is an example of additional steps that can be performed with the process in FIG. 9.

The process begins by identifying clusters of nodes (step 1400). The process changes an organization of workers based on an alignment between the organization of the workers into a set of groupings of the workers and the workers in the clusters of nodes (step 1402). The process terminates thereafter. In step 1402, workers in a cluster of nodes may not correspond to the team department in the structure of an organization. For example, the cluster of nodes made contain workers that are located in two different teams in the organization. This difference in alignment between the cluster of nodes and organization of teams can be considered in determining whether the change should be made in the organizational structure.

In step 1402, the change in the organization of the workers can include changing at least one of a reporting chain, a composition of a team, or other changes to the manner in which an organization is structured.

With reference to FIG. 15, a flowchart of a process for scheduling access to a set of physical locations is depicted in accordance with an illustrative embodiment. The process in FIG. 15 can be implemented in hardware, software, or both. When implemented in software, the process can take the form of program code that is run by one or more processor units located in one or more hardware devices in one or more computer systems. For example, the process can be implemented in at least one of scheduler 142 in server computer 104 in FIG. 1 or scheduler 214 in processor units 216 in computer system 218 in FIG. 2.

The process generates a schedule for workers to use work areas in a set of physical locations using a collaboration network comprising nodes representing workers and edges having weights representing interactions between workers in which the interactions are based on communications information sent between the workers (step 1500). In step 1500, the schedule increases in-person interactions between the workers when working at the set of physical locations using the schedule.

The process performs a set of actions using the schedule (step 1502). The process terminates thereafter.

The flowcharts and block diagrams in the different depicted embodiments illustrate the architecture, functionality, and operation of some possible implementations of apparatuses and methods in an illustrative embodiment. In this regard, each block in the flowcharts or block diagrams can represent at least one of a module, a segment, a function, or a portion of an operation or step. For example, one or more of the blocks can be implemented as program code, hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams may be implemented using special purpose hardware systems that perform the different operations or combinations of special purpose hardware and program code run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

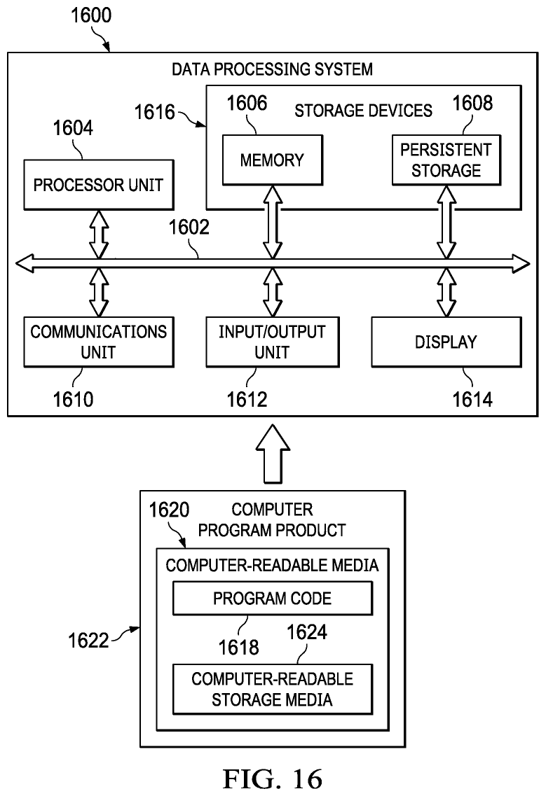

Turning now to FIG. 16, a block diagram of a data processing system is depicted in accordance with an illustrative embodiment. Data processing system 1600 can be used to implement server computer 104, server computer 106, and client devices 110 in FIG. 1. Data processing system 1600 can also be used to implement computer system 218 in FIG. 2.

In this illustrative example, data processing system 1600 includes communications framework 1602, which provides communications between processor unit 1604, memory 1606, persistent storage 1608, communications unit 1610, input/output (I/O) unit 1612, and display 1614. In this example, communications framework 1602 takes the form of a bus system.

Processor unit 1604 serves to execute instructions for software that can be loaded into memory 1606. Processor unit 1604 includes one or more processors. For example, processor unit 1604 can be selected from at least one of a multicore processor, a central processing unit (CPU), a graphics processing unit (GPU), a physics processing unit (PPU), a digital signal processor (DSP), a network processor, or some other suitable type of processor. Further, processor unit 1604 can may be implemented using one or more heterogeneous processor systems in which a main processor is present with secondary processors on a single chip. As another illustrative example, processor unit 1604 can be a symmetric multi-processor system containing multiple processors of the same type on a single chip.

Memory 1606 and persistent storage 1608 are examples of storage devices 1616. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 1616 may also be referred to as computer-readable storage devices in these illustrative examples. Memory 1606, in these examples, can be, for example, a random-access memory or any other suitable volatile or non-volatile storage device. Persistent storage 1608 may take various forms, depending on the particular implementation.

For example, persistent storage 1608 may contain one or more components or devices. For example, persistent storage 1608 can be a hard drive, a solid-state drive (SSD), a flash memory, a rewritable optical disk, a rewritable magnetic tape, or some combination of the above. The media used by persistent storage 1608 also can be removable. For example, a removable hard drive can be used for persistent storage 1608.

Communications unit 1610, in these illustrative examples, provides for communications with other data processing systems or devices. In these illustrative examples, communications unit 1610 is a network interface card.

Input/output unit 1612 allows for input and output of data with other devices that can be connected to data processing system 1600. For example, input/output unit 1612 may provide a connection for user input through at least one of a keyboard, a mouse, or some other suitable input device. Further, input/output unit 1612 may send output to a printer. Display 1614 provides a mechanism to display information to a user.

Instructions for at least one of the operating system, applications, or programs can be located in storage devices 1616, which are in communication with processor unit 1604 through communications framework 1602. The processes of the different embodiments can be performed by processor unit 1604 using computer-implemented instructions, which may be located in a memory, such as memory 1606.

These instructions are program instructions and are also referred to as program code, computer usable program code, or computer-readable program code that can be read and executed by a processor in processor unit 1604. The program code in the different embodiments can be embodied on different physical or computer-readable storage media, such as memory 1606 or persistent storage 1608.

Program code 1618 is located in a functional form on computer-readable media 1620 that is selectively removable and can be loaded onto or transferred to data processing system 1600 for execution by processor unit 1604. Program code 1618 and computer-readable media 1620 form computer program product 1622 in these illustrative examples. In the illustrative example, computer-readable media 1620 is computer-readable storage medium 1624.

Computer-readable storage medium 1624 is a physical or tangible storage device used to store program code 1618 rather than a medium that propagates or transmits program code 1618. Computer-readable storage medium 1624, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program code 1618 can be transferred to data processing system 1600 using a computer-readable signal media. The computer-readable signal media are signals and can be, for example, a propagated data signal containing program code 1618. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 1620” can be singular or plural. For example, program code 1618 can be located in computer-readable media 1620 in the form of a single storage device or system. In another example, program code 1618 can be located in computer-readable media 1620 that is distributed in multiple data processing systems. In other words, some instructions in program code 1618 can be located in one data processing system while other instructions in program code 1618 can be located in one data processing system. For example, a portion of program code 1618 can be located in computer-readable media 1620 in a server computer while another portion of program code 1618 can be located in computer-readable media 1620 located in a set of client computers.

The different components illustrated for data processing system 1600 are not meant to provide architectural limitations to the manner in which different embodiments can be implemented. The different illustrative embodiments can be implemented in a data processing system including components in addition to or in place of those illustrated for data processing system 1600. Other components shown in FIG. 16 can be varied from the illustrative examples shown. The different embodiments can be implemented using any hardware device or system capable of running program code 1618.

The description of the different illustrative embodiments has been presented for purposes of illustration and description and is not intended to be exhaustive or limited to the embodiments in the form disclosed. In some illustrative examples, one or more of the components may be incorporated in or otherwise form a portion of, another component. For example, memory 1606, or portions thereof, may be incorporated in processor unit 1604 in some illustrative examples.

Thus, illustrative embodiments provide a method, apparatus, computer system, and computer program product for resource scheduling. In one illustrative example, workers assigned to a set of locations are identified by a set of processor units. A collaboration network is identified by the set of processor units in which the collaboration network comprises nodes representing the workers and edges having weights representing interactions between the workers in which the interactions are based on communications information sent between the workers in a computer system. A schedule is generated by the set of processor units for the workers to work at the set of locations using the collaboration network.

Thus, communications information representing communications sent between workers can be used to generate schedules for workers. The creation of a collaboration network identifying interactions between workers through communications information can be used to generate schedules.

In the illustrative example, the schedule increases in-person interactions between the workers working at the set of locations using the schedule. Further, the schedule can reduce office usage in addition to increasing the in-person interactions between the workers when working at the set of locations using the schedule. In other words, a more efficient use of work areas in a location such as an office building can be achieved using the schedule generated in the different illustrative examples. As a result, this more efficient use of work areas in a location can be used to schedule additional workers in addition to the workers originally scheduled for the number of workers schedule can meet limits or caps on the number of people that can be scheduled to work in a particular location.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method for scheduling access to a set of locations, the method comprising:
identifying, by a set of processor units, workers assigned to the set of locations;
identifying, by the set of processor units, a collaboration network comprising nodes representing the workers and edges having weights representing interactions between the workers in which the interactions are based on communications information sent between the workers in a computer system; and
generating, by the set of processor units, a schedule for the workers to work at the set of locations using the collaboration network.

2. The method of claim 1 further comprising:
identifying, by the set of processor units, communications information sent between the workers within the computer system, wherein the workers are associated with the set of work locations; and
generating, by the set of processor units, the collaboration network using the communications information.

3. The method of claim 1, wherein generating, by the set of processor units, the schedule for the workers to work at the set of locations using the collaboration network comprises:
identifying, by the set of processor units, a cluster of nodes in the collaboration network based on the communications information sent between the workers; and
generating, by the set of processor units, the schedule for the workers to work at the set of locations using the collaboration network, wherein the schedule overlaps times that the workers in the cluster of nodes access the set of locations.

4. The method of claim 3, wherein the workers in the cluster of nodes are from one of a single team or a plurality of teams.

5. The method of claim 3, wherein a size of the cluster of nodes is limited by at least one of an office capacity or a number of days of work.

6. The method of claim 1 further comprising:
determining, by the set of processor units, the weights for the edges using the communication information.

7. The method of claim 6, wherein determining, by the set of processor units, the weights for the edges using the communication information comprises:
determining, by the set of processor units, the weights for the edges using the communication information and a set of weight factors for the workers.

8. The method of claim 7, wherein the set of weight factors comprises at least one of a reporting chain for the workers, a current project, or a future project.

9. The method of claim 1 further comprising:
populating, by the set of processor units, a calendar with the schedule, wherein the calendar is for a worker in the workers and has entries for the worker.

10. The method of claim 9, wherein the calendar has entries for other workers.

11. The method of claim 1 further comprising:
identifying, by the set of processor units, clusters of nodes; and
changing, by the set of processor units, an organization of the workers based on an alignment between the organization of the workers into a set of groupings of the workers and the workers in the clusters of nodes.

12. The method of claim 1 further comprising:
generating, by the set of processor units, reservations for work areas in the set of locations for the workers.

13. The method of claim 1, wherein s in the nodes represents a single worker or a plurality of workers.

14. The method of claim 1, wherein the schedule reduces office use in addition to increasing in-person interactions between the workers when working at the set of locations using the schedule.

15. The method of claim 1, wherein the communications information comprises at least one of an email message, an instant messaging message, a chat message, a memorandum, or a text message.

16. The method of claim 1, wherein the set of locations is selected from at least one of a physical location, a virtual location, an office building, an office complex, a floor, a part of a floor, a city, and a metropolitan area.

17. The method of claim 1, wherein the workers are selected from at least one of an employee, a self-employed worker, or an independent contractor.

18. A method for scheduling access to a set of physical locations, the method comprising:
generating, by a set of processor units, a schedule for workers to use work areas in the set of physical locations using a collaboration network comprising nodes representing workers and edges having weights representing interactions between workers in which the interactions are based on communications information sent between the workers, wherein the schedule increases in-person interactions between the workers when working at the set of physical locations using the schedule; and
performing, by the set of processor units, a set of actions with using the schedule.

19. The method of claim 18 further comprising:
identifying, by the set of processor units, communications information sent between the workers within a computer system, wherein the workers are associated with the set of work locations; and
generating, by the set of processor units, the collaboration network using the communications information.

20. The method of claim 19 further comprising:
determining, by the set of processor units, the weights for the edges using the communication information.

21. The method of claim 20, wherein determining, by the set of processor units, the weights for the edges using the communication information comprises:
determining, by the set of processor units, the weights for the edges using the communication information and a set of weight factors for the workers.

22. The method of claim 21, wherein the set of weight factors comprises at least one of a reporting chain for the workers, a current project, or a future project.

23. The method of claim 19, wherein generating, by the set of processor units, the schedule for the workers to use work areas in the set of physical locations using the collaboration network comprises:
identifying, by the set of processor units, a cluster of nodes in the collaboration network based on the communications information sent between the workers; and
generating, by the set of processor units, the schedule for the workers to work at the set of locations using the collaboration network, wherein the schedule overlaps times that the workers in the cluster of nodes access the set of locations, wherein a size of the cluster of nodes is limited by at least one of an office capacity or a number of days of work.

24. The method of claim 18 further comprising:
identifying, by the set of processor units, clusters of nodes; and
changing, by the set of processor units, an organization of the workers based on an alignment between the organization of the workers into a set of groupings of the workers and the workers in the clusters of nodes.

25. The method of claim 18, wherein the set of actions is selected from at least one of sending the schedule to the workers, populating a calendar with the schedule, sending the schedule to a calendar service for the workers, or make a reservation for a work area in a physical location in the set of physical locations.

26. The method of claim 18, wherein a node in the nodes represents a single worker or a plurality of workers.

27. The method of claim 18, wherein the schedule reduces office use in addition to increasing in-person interactions by the workers.

28. The method of claim 18, wherein the communications information comprises at least one of an email message, an instant messaging message, a chat message, a memorandum, or a text message.

29. The method of claim 18, wherein the set of physical locations is selected from at least one of an office building, an office complex, a floor, a part of a floor, a city, and a metropolitan area.

30. A scheduling system comprising:
a set of processor units; and
a scheduler in the set of processor units, wherein the scheduler is configured to:
identify workers assigned to a set of locations;
identify a collaboration network comprising nodes representing the workers and edges having weights representing interactions between the workers in which the interactions are based on communications information sent between the workers in a computer system; and
generate a schedule for the workers to work at the set of locations using the collaboration network.

31. The scheduling system of claim 30, wherein the scheduler is configured to:
identify communications information sent between the workers within the computer system, wherein the workers are associated with the set of work locations; and
generate the collaboration network using the communications information.

32. The scheduling system of claim 30, wherein in generating, by the set of processor units, the schedule for the workers to work at the set of locations using the collaboration network, the scheduler is configured to:
identify a cluster of nodes in the collaboration network based on the communications information sent between the workers; and
generate the schedule for the workers to work at the set of locations using the collaboration network, wherein the schedule overlaps times that the workers in the cluster of nodes access the set of locations.

33. The scheduling system of claim 32, wherein the workers in the cluster of nodes are from one of a single team or a plurality of teams.

34. The scheduling system of claim 32, wherein a size of the cluster of nodes is limited by at least one of an office capacity or a number of days of work.

35. The scheduling system of claim 30, wherein the scheduler is configured to:
determine weights for the edges using the communication information.

36. The scheduling system of claim 35, wherein in determining the weights for the edges using the communication information, wherein the scheduler is configured to:
determine the weights for the edges using the communication information and a set of weight factors for of the workers.

37. The scheduling system of claim 36, wherein the set of weight factors comprises at least one of a reporting chain for the workers, a current project, or a future project.

38. The scheduling system of claim 30, wherein the scheduler is configured to:
populate a calendar with the schedule, wherein the calendar is for a worker in the workers and has entries for the worker.

39. The scheduling system of claim 38, wherein the calendar has entries for other workers.

40. The scheduling system of claim 30, wherein the scheduler is configured to:
identify clusters of nodes; and
change an organization of the workers based on an alignment between the organization of the workers into a set of groupings of the workers and the workers in the clusters of nodes.

41. The scheduling system of claim 30, wherein a node in the nodes represents a single worker or a plurality of workers.

42. The scheduling system of claim 30, wherein the schedule reduces office use in addition to increasing in-person interactions between the workers when working at the set of locations using the schedule.

43. The scheduling system of claim 30, wherein the communications information comprises at least one of an email message, an instant messaging message, a chat message, a memorandum, or a text message.

44. The scheduling system of claim 30, wherein the set of locations is selected from at least one of physical location, a virtual location, an office building, an office complex, a floor, a part of a floor, a city, and a metropolitan area.

45. A scheduling system comprising:
a set of processor units; and
a scheduler in the set of processor units, wherein the scheduler is configured to:
generate a schedule for workers to use work areas in a set of physical locations using a collaboration network comprising nodes representing workers and edges having weights representing interactions between workers in which the interactions are based on communications information sent between the workers, wherein the schedule increases in-person interactions between the workers when working at the set of physical locations using the schedule; and
perform a set of actions using the schedule.

46. The scheduling system of claim 45, wherein the scheduler is configured to:
identify communications information sent between the workers within a computer system, wherein the workers are associated with the set of work locations; and
generate the collaboration network using the communications information.

47. The scheduling system of claim 46, wherein the scheduler is configured to:
determine weights for the edges using the communication information.

48. The scheduling system of claim 47, wherein in determining the weights for the edges using the communication information, wherein the scheduler is configured to:
determine the weights for the edges using the communication information and a set of weight factors for of the workers.

49. The scheduling system of claim 48, wherein the set of weight factors comprises at least one of a reporting chain for the workers, a current project, or a future project.

50. The scheduling system of claim 45, wherein the scheduler is configured to:
identify clusters of nodes; and
change an organization of the workers based on an alignment between the organization of the workers into a set of groupings of the workers and the workers in the clusters of nodes.

51. The scheduling system of claim 45, wherein the set of actions is selected from at least one of sending the schedule to the workers, populating a calendar with the schedule, sending the schedule to a calendar service for the workers, make a reservation for a work area in a physical location in the set of physical locations.

52. The scheduling system of claim 45, wherein a node in the nodes represents a single worker or a plurality of workers.

53. The scheduling system of claim 45, wherein the schedule reduces office use in addition to increasing in-person interactions by the workers.

54. The scheduling system of claim 45, wherein the communications information comprises at least one of an email message, an instant messaging message, a chat message, a memorandum, or a text message.

55. The scheduling system of claim 45, wherein the set of physical locations is selected from at least one of an office building, an office complex, a floor, a part of a floor, a city, and a metropolitan area.

56. A computer program product for scheduling resources, the computer program product comprising:
a computer-readable storage media;
first program code, stored on the computer-readable storage media, executable by a computer system to cause the computer system to identify workers assigned to a set of locations;
second program code, stored on the computer-readable storage media, executable by the computer system to cause the computer system to identify a collaboration network comprising nodes representing the workers and edges having weights representing interactions between the workers in which the interactions are based on communications information sent between the workers in a computer system; and
third program code, stored on the computer-readable storage media, executable by the computer system to cause the computer system to generate a schedule for the workers to work at the set of locations using the collaboration network, wherein the schedule increases in-person interactions between the workers working at the set of locations using the schedule.

57. A computer program product for scheduling resources, the computer program product comprising:
a computer-readable storage media;
first program code, stored on the computer-readable storage media, executable by a computer system to cause the computer system to generate a schedule for workers to use work areas in a set of physical locations using a collaboration network comprising nodes representing workers and edges having weights representing interactions between workers in which the interactions are based on communications information sent between the workers, wherein the schedule increases in-person interactions between the workers when working at the set of physical locations using the schedule; and
second program code, stored on the computer-readable storage media, executable by the computer system to cause the computer system to perform a set of actions using the schedule.
